(19) United States
(12) Patent Application Publication
(10) Pub. No.: US 2017/0034564 A1
(43) Pub. Date: Feb. 2, 2017

(54) Method and TV Associated Communication Device for Switching User Personalized Interface

(71) Applicant: Telefonaktiebolaget LM Ericsson (publ), Stockholm (SE)

(72) Inventor: Shaheer Jamal-Syed, Shanghai (CN)

(73) Assignee: Telefonaktiebolaget LM Ericsson (publ), Stockholm (SE)

(21) Appl. No.: 15/105,734

(22) PCT Filed: Dec. 19, 2013
(86) PCT No.: PCT/CN2013/089961

§ 371 Date: Jun. 17, 2016

(51) Int. Cl. H04N 21/431; H04N 21/258; H04N 21/441; H04N 21/435; H04N 21/84; H04N 21/658; H04N 21/41

(52) U.S. Cl. CPC H04N 21/431; H04N 21/6581; H04N 21/25891; H04N 21/4126; H04N 21/4351; H04N 21/84; H04N 21/441

(57) ABSTRACT

The disclosure provides a method (200) and TV associated communication device for switching user personalized interface performed by a TV associated communication device. The method (200) comprises: pairing (S210) the communication device with a first user device; obtaining (S220) a first identifier; receiving (S230) personalized configuration data for the first user; outputting (S240) to a TV set a signal based on the personalized configuration data for the first user that enables the TV set to display a first personalized interface; receiving (S250) a request from a second user device; pairing (S260) the communication device with the second user device in response to the request; obtaining (S270) from the second user device a second identifier; receiving (S280) personalized configuration data for the second user; and outputting (S290) to the TV set a signal based on the personalized configuration data for the second user that enables the TV set to display a second personalized interface.

### TECHNICAL FIELD

The disclosure generally relates to television (TV)-related technology, and more particularly, to a method, TV associated communication device, computer program and computer program product for switching user personalized interface.

### BACKGROUND

While it becomes increasingly popular to deliver and view video and audio content over the Internet, also known as Over-The-Top (OTT) viewing, TV sets and Set Top Boxes (STBs) are still a stable market and will continue to co-exist with an expanding number of OTT viewing devices (such as personal computers, tablets and smart phones).

STBs connected to TVs are more and more allowing a certain level of personalization by introducing a concept of “my content” where a user can store bookmarks for his/her favorite contents such as movies, videos, episodes of TV series and the like.

In order to provide a user with a seamless personalized experience across a number of devices including TVs, computers and mobile terminals, a “multi-screen” technique has been proposed. With this technique, the user can access his/her personalized interface and/or content by e.g., logging into a user account hosted at a server via any of these devices.

However, it is troublesome for a TV user to log into his/her account (e.g., by entering a username and a password) each time he/she wants to watch his/her personalized content. It becomes even more inconvenient when it is desired to switch from a personalized interface for User A to a personalized interface for User B: User A needs to log out first and then User B logs in by entering his/her username and password.

WO 2008/022338A2 discloses a method for sending presence-based content to a mobile device. With this method, when a user's mobile device is proximate to or within range of a wireless access point, a content provider can provide content that might be of interest to the user based on the “presence” of the device.

However, there is still a need for an improved solution for providing seamless personalization in a more user-friendly and efficient manner, especially when it is desired to switch user personalized interface.

### SUMMARY

It is an object of the disclosure to provide a method and TV associated communication device for switching user personalized interface as well as associated computer program and computer program product, capable of providing user personalized experience in a more user-friendly and efficient manner.

According to a first aspect of the disclosure, a method for switching user personalized interface is provided. The method is performed by a TV associated communication device and comprises the following steps of: pairing the communication device with a first user device; obtaining from the first user device a first identifier associated with the first user device or a first user of the first user device and forwarding the first identifier to a configuration server; receiving personalized configuration data for the first user from the configuration server; outputting to an associated TV set a signal based on the personalized configuration data for the first user that enables the TV set to display a first personalized interface associated with the first user; receiving a request from a second user device to be paired with the communication device, wherein the request is initiated by a manual action; pairing the communication device with the second user device in response to the request; obtaining from the second user device a second identifier associated with the second user device or a second user of the second user device and forwarding the second identifier to the configuration server; receiving personalized configuration data for the second user from the configuration server; and outputting to the TV set a signal based on the personalized configuration data for the second user that enables the TV set to display a second personalized interface associated with the second user.

In an embodiment, said pairing of the TV associated communication device with the first user device comprises: receiving a request from the first user device, pairing the communication device with the first user device in response to the request from the first user device. The request from the first user device may be initiated by a manual action.

In an embodiment, the first identifier uniquely identifies the first user device or the first user's subscription to a telecommunication service and the second identifier uniquely identifies the second user device or the second user's subscription to a telecommunication service.

In an embodiment, the method further comprises, upon receiving a first selection by the first user from the first personalized interface: retrieving from a media server a first content associated with the first selection; and outputting to the TV set a signal that enables the TV set to display the first content. The method further comprises, upon receiving a second selection by the second user from the second personalized interface: retrieving from a media server a second content associated with the second selection; and outputting to the TV set a signal that enables the TV set to display the second content.

In an embodiment, the method further comprises, upon receiving from the configuration server a request for first user information required for creating a user profile for the first user at the configuration server: outputting to the TV set a signal that enables the TV set to display a prompting interface for the first user to enter the first user information; and transmitting the first user information to the configuration server. The method further comprises, upon receiving from the configuration server a request for second user information required for creating a user profile for the second user at the configuration server: outputting to the TV set a signal that enables the TV set to display a prompting interface for the second user to enter the second user information; and transmitting the second user information to the configuration server.

In an embodiment, the TV associated communication device is a Set Top Box (STB).

According to a second aspect of the disclosure, a TV associated communication device for switching user personalized interface is provided. The TV associated communication device comprises: a pairing unit for pairing the TV associated communication device with a first user device; an obtaining unit for obtaining from the first user device a first identifier associated with the first user device or a first user of the first user device and forwarding the first identifier to a configuration server; a first receiving unit for receiving personalized configuration data for the first user from the configuration server; and an outputting unit for outputting to an associated TV set a signal based on the personalized configuration data for the first user that enables the TV set to display a first personalized interface associated with the first user. Said pairing unit is further configured to receive a request from a second user device to be paired with the communication device and pair the communication device with the second user device in response to the request, wherein the request is initiated by a manual action. Said obtaining unit is further configured to obtain from the second user device a second identifier associated with the second user device or a second user of the second user device and forward the second identifier to the configuration server. Said first receiving unit is further configured to receive personalized configuration data for the second user from the configuration server; and said outputting unit is further configured to output to the TV set a signal based on the personalized configuration data for the second user that enables the TV set to display a second personalized interface associated with the second user.

In an embodiment, said pairing unit is further configured to receive a request from the first user device and pair the communication device with the first user device in response to the request from the first user device.

In an embodiment, the first identifier uniquely identifies the first user device or the first user's subscription to a telecommunication service and the second identifier uniquely identifies the second user device or the second user's subscription to a telecommunication service.

In an embodiment, the TV associated communication device further comprises: a second receiving unit for receiving a first selection by the first user from the first personalized interface; and a retrieving unit for retrieving from a media server a first content associated with the first selection. Said outputting unit is further configured to output to the TV set a signal that enables the TV set to display the first content. Said second receiving unit is further configured to receive a second selection by the second user from the second personalized interface. Said retrieving unit is further configured to retrieve from a media server a second content associated with the second selection. Said outputting unit is further configured to output to the TV set a signal that enables the TV set to display the second content.

In an embodiment, the TV associated communication device further comprises: a third receiving unit for receiving from the configuration server a request for first user information required for creating a user profile for the first user at the configuration server. Said outputting unit is further configured to output to the TV set a signal that enables the TV set to display a prompting interface for the first user to enter the first user information. The TV associated communication device further comprises a transmitting unit for transmit the first user information to the configuration server. Said third receiving unit is further configured to receive from the configuration server a request for second user information required for creating a user profile for the second user at the configuration server. Said outputting unit is further configured to output to the TV set a signal that enables the TV set to display a prompting interface for the second user to enter the second user information. Said transmitting unit is further configured to transmit the second user information to the configuration server.

According to a third aspect of the disclosure, a TV associated communication device is provided. The TV associated communication device comprises a processor and a memory. Said memory comprises instructions executable by said processor whereby said TV associated communication device is operative to: pair the TV associated communication device with a first user device; obtain from the first user device a first identifier associated with the first user device or a first user of the first user device and forward the first identifier to a configuration server; receive personalized configuration data for the first user from the configuration server; output to an associated TV set a signal based on the personalized configuration data for the first user that enables the TV set to display a first personalized interface associated with the first user; receive a request from a second user device to be paired with the communication device, wherein the request is initiated by a manual action; pair the communication device with the second user device in response to the request; obtain from the second user device a second identifier associated with the second user device or a second user of the second user device and forward the second identifier to the configuration server; receive personalized configuration data for the second user from the configuration server; and output to the TV set a signal based on the personalized configuration data for the second user that enables the TV set to display a second personalized interface associated with the second user.

In an embodiment, said pairing of the TV associated communication device with the first user device comprises: receiving a request from the first user device; pairing the communication device with the first user device in response to the request from the first user device.

In an embodiment, the first identifier uniquely identifies the first user device or the first user's subscription to a telecommunication service and the second identifier uniquely identifies the second user device or the second user's subscription to a telecommunication service.

In an embodiment, said memory further contains instructions executable by said processor whereby said TV associated communication device is operative to: upon receiving a first selection by the first user from the first personalized interface: retrieve from a media server a first content associated with the first selection; and output to the TV set a signal that enables the TV set to display the first content, and upon receiving a second selection by the second user from the second personalized interface: retrieve from a media server a second content associated with the second selection; and output to the TV set a signal that enables the TV set to display the second content.

In an embodiment, said memory further contains instructions executable by said processor whereby said TV associated communication device is operative to: upon receiving from the configuration server a request for first user information required for creating a user profile for the first user at the configuration server: output to the TV set a signal that enables the TV set to display a prompting interface for the first user to enter the first user information; and transmit the first user information to the configuration server, and upon receiving from the configuration server a request for second user information required for creating a user profile for the second user at the configuration server: output to the TV set a signal that enables the TV set to display a prompting interface for the second user to enter the second user information; and transmit the second user information to the configuration server.

According to a fourth aspect of the disclosure, a computer program is provided. The computer program comprises computer readable instructions which, when run on an TV associated communication device, cause the TV associated communication device to: pair the TV associated communication device with a first user device; obtain from the first user device a first identifier associated with the first user device or a first user of the first user device and forward the first identifier to a configuration server; receive personalized configuration data for the first user from the configuration server; output to an associated TV set a signal based on the personalized configuration data for the first user that enables the TV set to display a first personalized interface associated with the first user; receive a request from a second user device to be paired with the communication device, wherein the request is initiated by a manual action; pair the communication device with the second user device in response to the request; obtain from the second user device a second identifier associated with the second user device or a second user of the second user device and forward the second identifier to the configuration server; receive personalized configuration data for the second user from the configuration server; and output to the TV set a signal based on the personalized configuration data for the second user that enables the TV set to display a second personalized interface associated with the second user.

According to a fifth aspect of the disclosure, a computer program storage product is provided. The computer program product comprises computer readable storage means storing the computer program of the above fourth aspect.

With the embodiments of the disclosure, an identifier associated with a user device or a user of the user device is obtained and there is thus no need for the user to manually enter his/her username and password to log into his/her account.

When it is desired to switch from the personalized interface associated with the first user to the personalized interface associated with the second user, a request is sent from the second user device for pairing with the communication device. After the communication device is paired with the second user device, the second identifier can be obtained, which eliminates the need for the logout by the first user and the login by the second user. In this way, the personalized interface can switched in a more efficient and user-friendly manner.

### BRIEF DESCRIPTION OF THE DRAWINGS

The above and other objects, features and advantages will be more apparent from the following description of embodiments with reference to the figures, in which:

FIG. 1 is a schematic diagram of a use scenario of the disclosure;

FIG. 2 is a flowchart illustrating a method for switching user personalized interface according to an embodiment of the disclosure;

FIG. 3 is a sequence chart showing a process for switching user personalized interface according to an embodiment of the disclosure;

FIG. 4 is a sequence chart showing a process for creating a new user profile according to an embodiment of the disclosure;

FIG. 5 is a schematic diagram of a TV associated communication device for switching user personalized interface according to an embodiment of the disclosure; and

FIG. 6 is a schematic diagram of a TV associated communication device for switching user personalized interface according to an embodiment of the disclosure.

### DETAILED DESCRIPTION

The embodiments of the disclosure will be detailed below with reference to the drawings. It should be noted that the following embodiments are illustrative only, rather than limiting the scope of the disclosure.

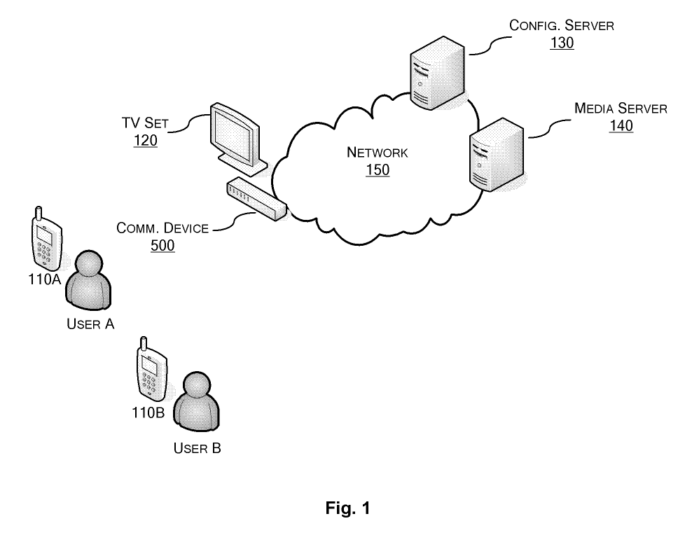

FIG. 1 is a schematic diagram of a use scenario of the disclosure. As shown, a user A has a user device 110A and a user B has a user device 110B. As an example, the user A and the user B are in a room where a TV set 120 and a TV associated communication device 500 are positioned. The TV associated communication device 500 is connected with a configuration server 130 and a media server 140 via a network 150 (e.g., internet). The details of these devices will be described hereinafter.

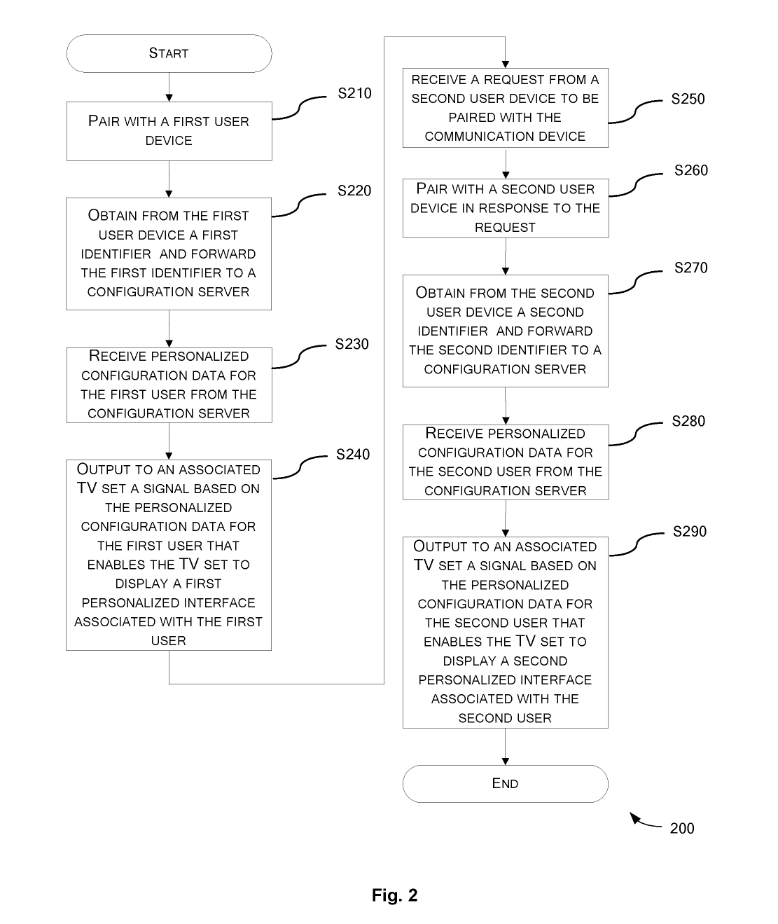

FIG. 2 is a flowchart illustrating a method 200 for switching user personalized interface according to an embodiment of the disclosure. The method 200 is performed by a TV associated communication device (e.g., the TV associated communication device 500 shown in FIG. 1). Here the TV associated communication device comprises but is not limited to a Set Top Box (STB) or a communication module in a smart TV. The method 200 comprises the steps as described below.

At step S210, the TV associated communication device 500 is paired with the user device 110A (first user device).

In particular, in the step S210, the communication device 500 can optionally receive a request from the user device 110A and then be paired with the user device 110A in response to the request. The request can be initiated by a manual action. Here the manual action could be pushing a button on a user interface/screen of the user device 110A, pushing a hardware/physical button of the user device or shaking or directing the user device in a certain way. For example, the user A (first user) of the user device 110A can push a virtual button displayed on the screen of the user device 110A to initiate a pairing process with the communication device 500 in accordance with e.g., the Bluetooth protocol. Other alternatives are of course also possible, e.g. other ways of taking advantage of accelerometers, gesture recognition software, pattern drawing recognition software etc that may be installed in the user device 110A. In the Bluetooth case, the user device 110A can send a Bluetooth pairing request to the communication device 500 and the communication device 500 can then be paired with the user device 110A following the Bluetooth pairing process. It can be appreciated by those skilled in the art that the disclosure is not limited to the Bluetooth protocol. Rather, other short range communication protocols can also be used. Alternatively to the manually initiated pairing described above, the pairing could be more automatic for the user device 110A, i.e. pairing without requiring any manual action like pushing a button or interacting with the user device 110A other than by getting the user device 110A within range for e.g. Bluetooth pairing. This latter alternative makes it even more convenient for the user A associated with the user device 110A to initiate a personalized configuration described further down.

At step S220, an identifier ID_A (first identifier) is obtained from the user device 110A and forwarded to the configuration server 130. The identifier ID_A is associated with the user device 110A or the user A.

In particular, the identifier ID_A can uniquely identify the user device 110A. For example, the identifier ID_A can be an International Mobile Equipment Identity (IMEI) number of the user device 110A. Alternatively, the identifier ID_A can uniquely identify the user A's subscription to a telecommunication service. For example, the identifier ID_A can be an International Mobile Subscriber Identity (IMSI) number or a Mobile Station Integrated Service Digital Network (MSISDN) number associated with the user A. The telecommunication service may be e.g. phone call service, messaging service, video conferencing service via a telecommunications network, an Internet access service and a Video-on-demand service.

In an example, the identifier ID_A can be obtained from the user device 110A via a Bluetooth connection established between the user device 110A and the communication device in the step S210. Here, the Bluetooth connection may or may not be maintained after the communication device obtains the identifier ID_A.

In an example, the identifier ID_A can be included in a Hyper Text Transfer Protocol (HTTP) GET request for transmission to the configuration server.

At step S230, personalized configuration data for the user A is received from the configuration server 130.

The configuration server maintains user profiles for users in association with identifiers. Each user profile contains personalized configuration data for a user, including information on the user's favorite interface styles and links of the user's favorite contents. Upon receiving the HTTP GET request sent in the step S220, the configuration server extracts the identifier ID_A from the HTTP GET request and uses it as a key to search for a user profile of the user A. If such user profile is found, the configuration server generates a HTTP response containing the personalized configuration data for the user A based on the user profile and sends it to the communication device. The communication device then receives the personalized configuration data from the configuration server. For instance, the personalized configuration data can be an eXtensible Markup Language (XML) file containing parameters for presenting a user interface (UI). An example of such XML file can be as follows, written in Java Script Object Notation (JSON) script:
userID: MSISDN_A //ID_A
userfirstname: John //User A's first name
userlastname: Doe //User A's last name
Age: 34 //User A's age
Desktoptheme: Dark_ocean //desktop theme of the UI
Font: Courier //font to be used in the UI
Fontsize: medium //size of the font
Icons: yes //whether to use icons in the UI
Iconsize: Medium //size of the icons
IconSet: Gothic_set_vikings //a set of predefined icons
desktopView: Classic //desktop view of the UI
FolderView: On //whether to use folder view in the UI
thumbnailView: On // whether to use thumbnail view in the UI
thumbnailSize: large_with_names //size of the thumbnails

The personalized configuration data may also contain links of the user A's favorite contents, e.g., contents the user A has purchased or flagged during his/her view experience.

At step S240, a signal based on the personalized configuration data for the user A is outputted to an associated TV set (e.g., the TV set 120 shown in FIG. 1). The signal enables the TV set 120 to display a personalized interface UI_A (first personalized interface) associated with the user A. For example, the signal contains the parameters for presenting the personalized interface UI_A and the links of the user A's favorite contents, as described above.

At step S250, a request is received from the user device 110B (second user device) to be paired with the communication device 500.

At step S260, the communication device is paired with the user device 110B in response to the request.

As in the first general alternative of step S210, the request is initiated by a manual action, which could be pushing a button on a user interface/screen of the user device or shaking directing the user device in a certain way. For example, the user B (second user) of the user device 110B can push a virtual button displayed on the screen of the user device 110B to initiate a pairing process with the communication device by sending a Bluetooth pairing request to the communication device and the communication device can then be paired with the user device 110A following the Bluetooth pairing process.

At step S270, an identifier ID_B (second identifier) is obtained from the user device 110B and forwarded to the configuration server 130. The identifier ID_B is associated with the user device 110B or the user B.

Like the identifier ID_A, the identifier ID_B can uniquely identify the user device 110B or the user B's subscription to a telecommunication service. For example, the identifier ID_B can be an IMEI number of the user device 110B or can be an IMSI number or an MSISDN number associated with the user B.

As in the step S220, the connection between the user device 110B and the communication device 500 may or may not be maintained after the communication device obtains the identifier ID_B. The identifier ID_B can be included in a HTTP GET request for transmission to the configuration server.

At step S280, personalized configuration data for the user B is obtained from the configuration server 130.

Upon receiving the HTTP GET request sent in the step S270, the configuration server 130 extracts the identifier ID_B from the HTTP GET request and uses it as a key to search for a user profile of the user B. If such user profile is found, the configuration server 130 generates a HTTP response containing the personalized configuration data for the user B based on the user profile and sends it to the communication device 500. The communication device 500 then receives the personalized configuration data from the configuration server 130. As described above in connection with the step S230, the personalized configuration data can be an eXtensible Markup Language (XML) file containing parameters for presenting a user interface. The personalized configuration data may also contain links of the user B's favorite contents, e.g., contents the user B has purchased or flagged during his/her view experience.

At step S290, a signal based on the personalized configuration data for the user B is outputted to the TV set 120. The signal enables the TV set 120 to display a personalized interface associated with the user B. For example, the signal contains the parameters for presenting the personalized interface UI_B and the links of the user B's favorite contents, as described above.

The method 200 may further include the following steps (not shown).

Upon receiving a selection by the user A from the personalized interface UI_A, the communication device 500 retrieves from the media server 140 a content associated with the selection and outputs to the TV set 120 a signal that enables the TV set to display the content.

Upon receiving a selection by the user B from the personalized interface UI_B, the communication device 500 retrieves from the media server 140 a content associated with the selection and outputs to the TV set 120 a signal that enables the TV set to display the content.

It is to be noted here that, if the configuration server 130 fails to find a user profile of the user A after receiving the identifier ID_A sent in the step S220, the configuration server 130 will send to the communication device 500 a request for user information required for creating a user profile for the user A at the configuration server 130. Upon receiving the request from the configuration server 130, the communication device 500 outputs to the TV set 120 a signal that enables the TV set to display a prompting interface for the user A to enter the user information and transmits the user information to the configuration server 130. Here the user information may include the name and age of the user A.

If the configuration server 130 fails to find a user profile of the user B after receiving the identifier ID_B sent in the step S270, the configuration server 130 will send to the communication device 500 a request for user information required for creating a user profile for the user B at the configuration server 130. Upon receiving the request from the configuration server 130, the communication device 500 outputs to the TV set 120 a signal that enables the TV set to display a prompting interface for the user B to enter the user information and transmits the user information to the configuration server.

Through the embodiments described above in conjunction with FIG. 2, it is enabled that the personalized interface associated with the first user can conveniently be displayed to the first user, who then more conveniently can choose interesting content to watch. Then when the second user enters the same area, e.g. the same room as where the TV and the TV associated communication device are positioned, the second user may change to the personalized interface of the second user by a certain manual action if he/she really wants to do that and perhaps after having asked the first user about it. This inventive mechanism enables a solution which takes into account that the second user perhaps just passes the room with his/her user device with no intention or desire of changing the personalized interface. Hence an undesired change of personalized interface is avoided and the first user can continue to watch the content without being disturbed by the second user who just passes by.

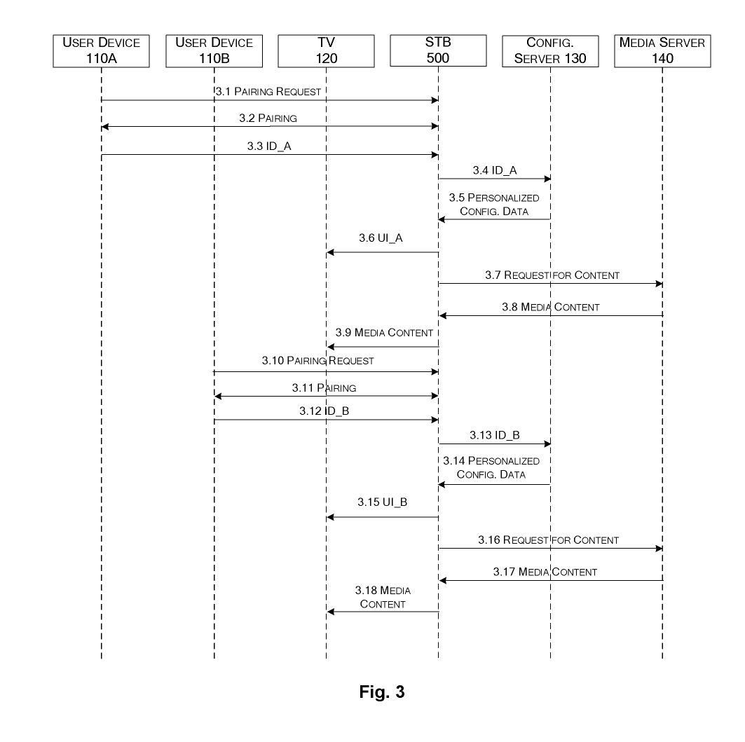

The above method 200 will be described in further detail with reference to FIG. 3, which is a sequence chart illustrating a process for switching user personalized interface.

At 3.1, the user device 110A sends a pairing request to the TV associated communication device 500 (which is an STB in this example). At 3.2, the STB 500 is paired with the user device 110A. At 3.3, the STB 500 receives an identifier ID_A (e.g., an MSISDN number) from the user device 110A. At 3.4, the STB 500 forwards the received identifier ID_A to the configuration server 130 e.g., in a HTTP GET request.

At 3.5, the configuration server 130 searches for a user profile based on the identifier ID_A and, if such user profile is found, generates a HTTP response (e.g., in an XML file) containing the personalized configuration data for the user A based on the user profile and sends it to the STB 500. At 3.6, the STB 500 parses the XML file and generates and outputs to the associated TV set 120 a signal based on the personalized configuration data for the user A that enables the TV set 120 to display the personalized interface UI_A associated with the user A.

At 3.7, the user A selects a media content from the personalized interface UI_A, and the STB 500 receives the selection by the user A and sends a request to the media server 140 for retrieving the selected media content. At 3.8, the media server 140 returns the requested media content to the STB 500. At 3.9, the STB 500 outputs to the TV set 120 a signal that enables the TV set to display the media content.

At 3.10, the user device 110B sends a pairing request to the STB 500. At 3.11, the STB 500 is paired with the user device 110B. At 3.12, the STB 500 receives an identifier ID_B (e.g., an MSISDN number) from the user device 110B. At 3.13, the STB 500 forwards the received identifier ID_B to the configuration server 130 e.g., in a HTTP GET request.

At 3.14, the configuration server 130 searches for a user profile based on the identifier ID_B and, if such user profile is found, generates a HTTP response (e.g., in an XML file) containing the personalized configuration data for the user B based on the user profile and sends it to the STB 500. At 3.15, the STB 500 parses the XML file and generates and outputs to the associated TV set 120 a signal based on the personalized configuration data for the user B that enables the TV set 120 to display the personalized interface UI_B associated with the user B.

At 3.16, the user B selects a media content from the personalized interface UI_B, and the STB 500 receives the selection by the user B and sends a request to the media server 140 for retrieving the selected media content. At 3.17, the media server 140 returns the requested media content to the STB 500. At 3.18, the STB 500 outputs to the TV set 120 a signal that enables the TV set 120 to display the media content.

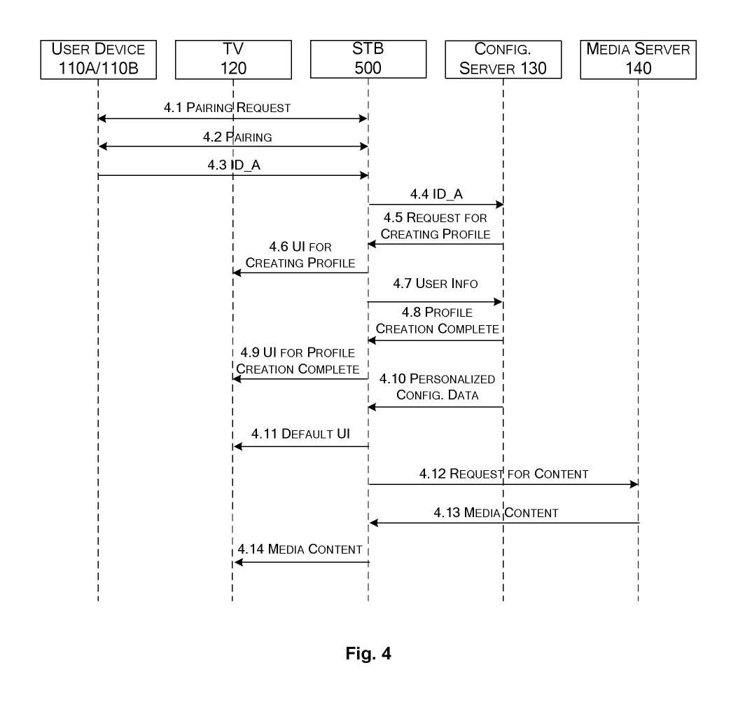

FIG. 4 is a sequence chart showing a process for creating a new user profile for the user A. The process for creating a new user profile for the user B is substantially the same as the process shown in FIG. 4.

At 4.1, the user device 110A sends a pairing request to the TV associated communication device 500 (which is an STB in this example). At 4.2, the STB 500 is paired with the user device 110A. At 4.3, the STB 500 receives an identifier ID_A (e.g., an MSISDN number) from the user device 110A. At 4.4, the STB 500 forwards the received identifier ID_A to the configuration server 130 e.g., in a HTTP GET request.

At 4.5, the configuration server 130 searches for a user profile based on the identifier ID_A and, if no user profile associated with the identifier ID_A is found, sends to the STB 500 a request for user information required for creating a user profile for the user A at the configuration server 130. At 4.6, upon receiving the request from the configuration server 130, the STB 500 outputs to the TV set 130 a signal that enables the TV set to display a prompting interface for the user A to enter the user information. At 4.7, the STB 500 receives the user information from the user A and transmits it to the configuration server 130. At 4.8, the configuration server 130 creates a new user profile for the user A and sends to the STB 500 an acknowledgement that the user profile has been created. At 4.9, the STB 500 outputs to the TV set 120 a signal that enables the TV set to display an interface for notifying the user A of completion of the creation of the user profile. At 4.10, the configuration server 130 sends to the STB 500 a default personalized data. At 4.11, the STB 500 outputs to the TV set 120 a signal that enables the TV set to display a default UI.

At 4.12, the user A selects media content from the default UI, and the STB 500 receives the selection by the user A and sends a request to the media server 140 for retrieving the selected media content. At 4.13, the media server 140 returns the requested media content to the STB 500. At 4.14, the STB 500 outputs to the TV set 120 a signal that enables the TV set to display the media content.

It can be appreciated by those skilled in the art that the configuration server 130 may update the user profile based on e.g., UI parameters the user has selected and/or contents the user has purchased or flagged as “favorite”.

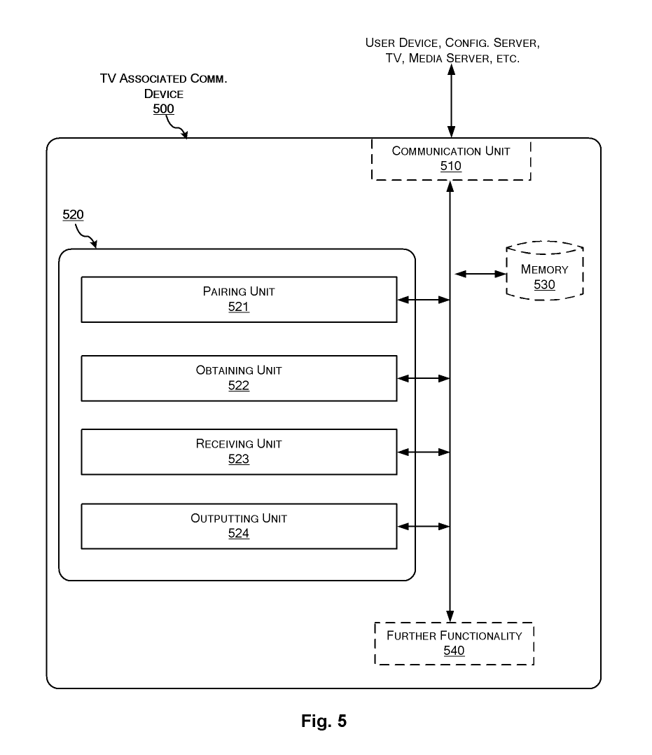

FIG. 5 is a schematic diagram of a TV associated communication device 500 for switching user personalized interface according to an embodiment of the disclosure.

As shown in FIG. 5, the communication device 500 includes a communication unit 510 for communicating with other entities such as a user device, a configuration server, a TV set and a media server. The communication device 500 further includes an arrangement 520 for implementing the method described above with reference to FIG. 2. The communication device 500 may further comprise one or more memories 530 and one or more further functional units 540, such as a functional unit for receiving a user input.

The arrangement 520 can be implemented as a pure hardware solution or as a combination of software and hardware, e.g., by one or more of: a processor or a micro processor and adequate software and memory for storing of the software, a Programmable Logic Device (PLD) or other electronic component(s) or processing circuitry configured to perform the actions described above, and illustrated, e.g., in FIG. 2. The arrangement 520 may be implemented and/or described as follows.

Referring to FIG. 5, the TV associated communication device 500 includes a pairing unit 521 for pairing the TV associated communication device with a first user device.

The communication device 500 further includes an obtaining unit 522 for obtaining from the first user device a first identifier associated with the first user device or a first user of the first user device and forwarding the first identifier to a configuration server.

The communication device 500 further includes a first receiving unit 523 for receiving personalized configuration data for the first user from the configuration server.

The communication device 500 further includes an outputting unit 524 for outputting to an associated TV set a signal based on the personalized configuration data for the first user that enables the TV set to display a first personalized interface associated with the first user.

The pairing unit 521 is further configured to receive a request from a second user device to be paired with the communication device and pair the communication device with the second user device in response to the request, wherein the request is initiated by a manual action.

The obtaining unit 522 is further configured to obtain from the second user device a second identifier associated with the second user device or a second user of the second user device and forward the second identifier to the configuration server.

The first receiving unit 523 is further configured to receive personalized configuration data for the second user from the configuration server.

The outputting unit 524 is further configured to output to the TV set a signal based on the personalized configuration data for the second user that enables the TV set to display a second personalized interface associated with the second user.

It is to be noted here that the respective units 521-524 can be implemented as software components or hardware circuits.

In an embodiment, the pairing unit 521 is further configured to receive a request from the first user device and pair the communication device with the first user device in response to the request from the first user device, wherein the request from the first user device is initiated by a manual action.

In an embodiment, the first identifier uniquely identifies the first user device or the first user's subscription to a telecommunication service and the second identifier uniquely identifies the second user device or the second user's subscription to a telecommunication service.

In an embodiment, the communication device 500 further comprises: a second receiving unit (not shown) for receiving a first selection by the first user from the first personalized interface; and a retrieving unit (not shown) for retrieving from a media server a first content associated with the first selection. The outputting unit 524 is further configured to output to the TV set a signal that enables the TV set to display the first content.

The second receiving unit is further configured to receive a second selection by the second user from the second personalized interface. The retrieving unit is further configured to retrieve from a media server a second content associated with the second selection. The outputting unit 524 is further configured to output to the TV set a signal that enables the TV set to display the second content.

In an embodiment, the communication device 500 further comprises: a third receiving unit (not shown) for receiving from the configuration server a request for first user information required for creating a user profile for the first user at the configuration server. The outputting unit 524 is further configured to output to the TV set a signal that enables the TV set to display a prompting interface for the first user to enter the first user information. The communication device 500 further comprises a transmitting unit (not shown) for transmit the first user information to the configuration server.

The third receiving unit is further configured to receive from the configuration server a request for second user information required for creating a user profile for the second user at the configuration server. The outputting unit 524 is further configured to output to the TV set a signal that enables the TV set to display a prompting interface for the second user to enter the second user information. The transmitting unit is further configured to transmit the second user information to the configuration server.

In an embodiment, the TV associated communication device 500 comprises a Set Top Box (STB); in another it is a module integrated in a TV monitor.

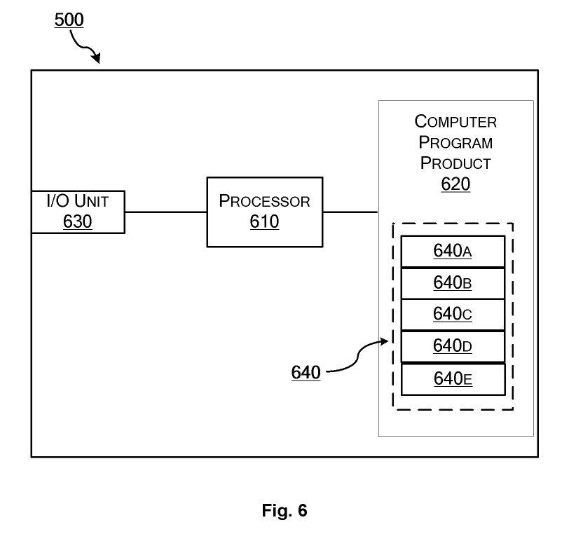

FIG. 6 shows an embodiment of the communication device 500 where above described units are implemented with the help of software. The communication device 500 includes a processor 610, e.g., a Digital Signal Processor (DSP). The processor 610 may be a single unit or a plurality of units to perform different actions of procedures described herein. The communication unit 500 may also comprise an input/output unit 530 for receiving/sending signal from/to other entities.

Furthermore, the communication unit 500 includes at least one computer program storage product 620 in the form of a non-volatile or volatile memory, e.g., an Electrically Erasable Programmable Read-Only Memory (EEPROM), a flash memory and a hard drive. In other words the computer program storage product 620 comprises or is, irrespective of embodiment, a non-transitory computer readable medium. The computer program storage product 620 includes a computer program 640, which includes code/computer readable instructions, which when executed by the processor 610 in the communication device 500 causes the communication device 500 in which it is included to perform the actions, e.g., of the procedure described earlier in conjunction with FIG. 2.

The computer program 640 may be configured as a computer program code comprising computer program parts 640A-640D.

Hence, in an exemplifying embodiment, the code in the computer program of the communication device 500 includes a pairing part 640A for pairing a TV associated communication device with a first user device. The code in the computer program of the communication device 500 includes an obtaining part 640B for obtaining from the first user device a first identifier associated with the first user device or a first user of the first user device and forwarding the first identifier to a configuration server. The code in the computer program of the communication device 500 includes a receiving part 640C for receiving personalized configuration data for the first user from the configuration server. The code in the computer program of the communication device 500 includes an outputting part 640D for outputting to an associated TV set a signal based on the personalized configuration data for the first user that enables the TV set to display a first personalized interface associated with the first user.

The pairing part 640A is further configured to receive a request from a second user device to be paired with the communication device and pair the communication device with the second user device in response to the request, wherein the request is initiated by a manual action. The obtaining part 640B is further configured to obtain from the second user device a second identifier associated with the second user device or a second user of the second user device and forward the second identifier to the configuration server. The receiving part 640C is further configured to receive personalized configuration data for the second user from the configuration server. The outputting part 640D is further configured to output to the TV set a signal based on the personalized configuration data for the second user that enables the TV set to display a second personalized interface associated with the second user.

The computer program parts could essentially when executed by the processor 610 cause the performance of the actions of the flow illustrated in FIG. 2, to emulate the arrangement 520 in the communication device 500. In other words, when the different computer program parts are executed in the processor 610, they may correspond, e.g., to the units 521-524 of FIG. 5.

Although the code means in the embodiments disclosed above in conjunction with FIG. 6 are implemented as computer program modules which when executed in the processing unit causes the device to perform the actions described above in conjunction with the figures mentioned above, at least one of the code means may in alternative embodiments be implemented at least partly as hardware circuits.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a computer readable medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories.

The disclosure has been described above with reference to embodiments thereof. It should be understood that various modifications, alternations and additions can be made by those skilled in the art without departing from the spirits and scope of the disclosure. Therefore, the scope of the disclosure is not limited to the above particular embodiments but only defined by the claims as attached.

1-20. (canceled)

21. A method for switching user personalized interface performed by a TV-associated communication device, comprising:
pairing the communication device with a first user device;
obtaining from the first user device a first identifier associated with the first user device or a first user of the first user device and forwarding the first identifier to a configuration server;
receiving personalized configuration data for the first user from the configuration server;
outputting to an associated TV set a signal based on the personalized configuration data for the first user that enables the TV set to display a first personalized interface associated with the first user;
receiving a request from a second user device to be paired with the communication device, wherein the request is initiated by a manual action;
pairing the communication device with the second user device in response to the request;
obtaining from the second user device a second identifier associated with the second user device or a second user of the second user device and forwarding the second identifier to the configuration server;
receiving personalized configuration data for the second user from the configuration server; and
outputting to the TV set a signal based on the personalized configuration data for the second user that enables the TV set to display a second personalized interface associated with the second user.

22. The method of claim 21, wherein said pairing of the communication device with the first user device comprises:
receiving a request from the first user device;
pairing the communication device with the first user device in response to the request from the first user device.

23. The method of claim 21, wherein the first identifier uniquely identifies the first user device or the first user's subscription to a telecommunication service and the second identifier uniquely identifies the second user device or the second user's subscription to a telecommunication service.

24. The method of claim 21, further comprising, upon receiving a first selection by the first user from the first personalized interface:
retrieving from a media server a first content associated with the first selection; and
outputting to the TV set a signal that enables the TV set to display the first content, and
upon receiving a second selection by the second user from the second personalized interface:
retrieving from a media server a second content associated with the second selection; and
outputting to the TV set a signal that enables the TV set to display the second content.

25. The method of claim 21, further comprising, upon receiving from the configuration server a request for first user information required for creating a user profile for the first user at the configuration server:
outputting to the TV set a signal that enables the TV set to display a prompting interface for the first user to enter the first user information; and
transmitting the first user information to the configuration server, and
upon receiving from the configuration server a request for second user information required for creating a user profile for the second user at the configuration server:
outputting to the TV set a signal that enables the TV set to display a prompting interface for the second user to enter the second user information; and
transmitting the second user information to the configuration server.

26. The method of claim 21, wherein the TV-associated communication device is a Set Top Box.

27. A TV-associated communication device for switching user personalized interface, comprising:
a pairing unit for pairing the TV-associated communication device with a first user device;
an obtaining unit for obtaining from the first user device a first identifier associated with the first user device or a first user of the first user device and forwarding the first identifier to a configuration server;
a first receiving unit for receiving personalized configuration data for the first user from the configuration server; and
an outputting unit for outputting to an associated TV set a signal based on the personalized configuration data for the first user that enables the TV set to display a first personalized interface associated with the first user;
wherein
said pairing unit is further configured to receive a request from a second user device to be paired with the communication device and pair the communication device with the second user device in response to the request, wherein the request is initiated by a manual action;
said obtaining unit is further configured to obtain from the second user device a second identifier associated with the second user device or a second user of the second user device and forward the second identifier to the configuration server;
said first receiving unit is further configured to receive personalized configuration data for the second user from the configuration server; and
said outputting unit is further configured to output to the TV set a signal based on the personalized configuration data for the second user that enables the TV set to display a second personalized interface associated with the second user.

28. The TV-associated communication device of claim 27, wherein said pairing unit is further configured to receive a request from the first user device and pair the communication device with the first user device in response to the request from the first user device, wherein the request from the first user device is initiated by a manual action.

29. The TV-associated communication device of claim 27, wherein the first identifier uniquely identifies the first user device or the first user's subscription to a telecommunication service and the second identifier uniquely identifies the second user device or the second user's subscription to a telecommunication service.

30. The TV-associated communication device of claim 27, further comprising:
a second receiving unit for receiving a first selection by the first user from the first personalized interface; and
a retrieving unit for retrieving from a media server a first content associated with the first selection,
wherein said outputting unit is further configured to output to the TV set a signal that enables the TV set to display the first content,
wherein:
said second receiving unit is further configured to receive a second selection by the second user from the second personalized interface,
said retrieving unit is further configured to retrieve from a media server a second content associated with the second selection, and
said outputting unit is further configured to output to the TV set a signal that enables the TV set to display the second content.

31. The TV-associated communication device of claim 27, further comprising:
a third receiving unit for receiving from the configuration server a request for first user information required for creating a user profile for the first user at the configuration server,
wherein said outputting unit is further configured to output to the TV set a signal that enables the TV set to display a prompting interface for the first user to enter the first user information, and
the TV-associated communication device further comprises a transmitting unit for transmit the first user information to the configuration server,
wherein:
said third receiving unit is further configured to receive from the configuration server a request for second user information required for creating a user profile for the second user at the configuration server,
said outputting unit is further configured to output to the TV set a signal that enables the TV set to display a prompting interface for the second user to enter the second user information; and
said transmitting unit is further configured to transmit the second user information to the configuration server.

32. The TV-associated communication device of claim 27, wherein the TV-associated communication device is a Set Top Box.

33. A TV-associated communication device comprising a processor and a memory, said memory comprising instructions executable by said processor whereby said TV-associated communication device is operative to:
pair the TV-associated communication device with a first user device;
obtain from the first user device a first identifier associated with the first user device or a first user of the first user device and forward the first identifier to a configuration server;
receive personalized configuration data for the first user from the configuration server;
output to an associated TV set a signal based on the personalized configuration data for the first user that enables the TV set to display a first personalized interface associated with the first user;
receive a request from a second user device to be paired with the communication device, wherein the request is initiated by a manual action;
pair the communication device with the second user device in response to the request;
obtain from the second user device a second identifier associated with the second user device or a second user of the second user device and forward the second identifier to the configuration server;
receive personalized configuration data for the second user from the configuration server; and
output to the TV set a signal based on the personalized configuration data for the second user that enables the TV set to display a second personalized interface associated with the second user.

34. The TV-associated communication device of claim 33, wherein said pairing of the communication device with the first user device comprises:
receiving a request from the first user device, wherein the request from the first user device is initiated by a manual action;
pairing the communication device with the first user device in response to the request from the first user device.

35. The TV-associated communication device of claim 33, wherein the first identifier uniquely identifies the first user device or the first user's subscription to a telecommunication service and the second identifier uniquely identifies the second user device or the second user's subscription to a telecommunication service.

36. The TV-associated communication device of claim 33, said memory further contains instructions executable by said processor whereby said TV-associated communication device is operative to:
upon receiving a first selection by the first user from the first personalized interface:
retrieve from a media server a first content associated with the first selection; and
output to the TV set a signal that enables the TV set to display the first content, and upon receiving a second selection by the second user from the second personalized interface:
retrieve from a media server a second content associated with the second selection; and
output to the TV set a signal that enables the TV set to display the second content.

37. The TV-associated communication device of claim 33, said memory further contains instructions executable by said processor whereby said TV-associated communication device is operative to:
upon receiving from the configuration server a request for first user information required for creating a user profile for the first user at the configuration server:
output to the TV set a signal that enables the TV set to display a prompting interface for the first user to enter the first user information; and
transmit the first user information to the configuration server, and
upon receiving from the configuration server a request for second user information required for creating a user profile for the second user at the configuration server:
output to the TV set a signal that enables the TV set to display a prompting interface for the second user to enter the second user information; and
transmit the second user information to the configuration server.

38. The TV-associated communication device of claim 33, wherein the TV-associated communication device is a Set Top Box.

39. A computer program storage product comprising a non-transitory computer-readable storage medium storing a computer program comprising computer readable instructions that, when run on a TV-associated communication device, cause the TV-associated communication device to:
pair the TV-associated communication device with a first user device;
obtain from the first user device a first identifier associated with the first user device or a first user of the first user device and forward the first identifier to a configuration server;
receive personalized configuration data for the first user from the configuration server;
output to an associated TV set a signal based on the personalized configuration data for the first user that enables the TV set to display a first personalized interface associated with the first user;
receive a request from a second user device to be paired with the communication device, wherein the request is initiated by a manual action;
pair the communication device with the second user device in response to the request;
obtain from the second user device a second identifier associated with the second user device or a second user of the second user device and forward the second identifier to the configuration server;
receive personalized configuration data for the second user from the configuration server; and
output to the TV set a signal based on the personalized configuration data for the second user that enables the TV set to display a second personalized interface associated with the second user.
